(19) United States
(12) Patent Application Publication
(10) Pub. No.: US 2023/0239525 A1
(43) Pub. Date: Jul. 27, 2023

(54) SERVER, METHOD AND TERMINAL

(71) Applicant: 17LIVE Japan Inc., Tokyo (JP)

(72) Inventors: Yu Chuan CHANG, Taipei City (TW); Po-Sheng CHIU, Taipei City (TW); Cheng-Hsiang WENG, Taipei City (TW)

(21) Appl. No.: 17/992,415

(22) Filed: Nov. 22, 2022

(30) Foreign Application Priority Data
Jan. 21, 2022 (JP) 2022-007652

(51) Int. Cl. H04N 21/2662; H04N 21/2187

(52) U.S. Cl. CPC H04N 21/2662; H04N 21/2187

(57) ABSTRACT

A server includes: a determining unit adapted to determine a bit rate or an upper limit of the bit rate of video data generated by a user terminal of a distributor, the distributor participating in a live-stream in which a plurality of distributors are allowed to participate, the bitrate or the upper limit being determined such that the bit rate or the upper limit is lowered as a number of the distributors participating in the live-stream increases; an informing unit adapted to inform the user terminal of the distributor of the determined bit rate or upper limit over a network; and a receiving unit adapted to receive the video data from user terminals of the plurality of distributors participating in the live-stream over the network.

### CROSS-REFERENCE TO RELATED APPLICATIONS

This application is based on and claims the benefit of priority from Japanese Patent Application Serial No. 2022-7652 (filed on Jan. 21, 2022), the contents of which are hereby incorporated by reference in their entirety.

### TECHNICAL FIELD

The present disclosure relates to a server, a method, and a terminal.

### BACKGROUND

With the development of IT technology, the way information is exchanged has changed. In the Showa period (1926-1989), one-way information communication via newspapers and television was the main stream. In the Heisei period (1990-2019), with the widespread availability of cell phones and personal computers, and the significant improvement in Internet communication speed, instantaneous interactive communication services such as chat services emerged, and on-demand video distribution services also become popular as storage costs were reduced. And nowadays, with the sophistication of smartphones and further improvements in network speed as typified by 5G, services that enable real-time communication through video, especially live-stream services, are gaining recognition. The number of users of live-stream services is expanding, especially among young people, as such services allow people to share fun moments even when they are in physically separate locations from each other.

“Group Call,” 17 LIVE, URL:https://helpfeel.com/17media-jp/Group_Call-60daae9216d6af0022bcb373, discloses a group call function that realizes a live-streaming in which a plurality of distributors (streamers) are able to participate simultaneously.

Networks have been basically configured on the premise that a single distributor live-streams to a large number of viewers. Live-streaming in which a plurality of distributors participate, as typified by the group call function, does not stand on this premise, and therefore it is desired to provide a new streaming system based on the characteristics of such a live-streaming.

### SUMMARY

In view of the above, one object of the present disclosure is to provide a technology that can realize a streaming system tailored to live-streaming in which a plurality of distributors participate.

One aspect of the present disclosure relates to a server. The server includes: a determining unit adapted to determine either a bit rate or an upper limit of the bit rate of video data generated by a user terminal of a distributor, the distributor participating in a live-stream in which a plurality of distributors are allowed to participate, the bit rate or the upper limit of the bit rate being determined such that the bit rate or the upper limit of the bit rate is lowered as a number of the distributors participating in the live-stream increases; an informing unit adapted to inform the user terminal of the distributor of the determined bit rate or the upper limit over a network; and a receiving unit adapted to receive the video data from user terminals of the plurality of distributors participating in the live-stream over the network.

Another aspect of the invention relates to a user terminal. A user terminal of a distributor participating in a live-stream in which a plurality of distributors are allowed to participate, includes: one or more processors; and memory storing one or more computer programs configured to be executed by the one or more processors. The one or more computer programs includes instructions for: generating video data at a bit rate that is adjusted such that the bit rate is lowered as a number of the distributors participating in the live-stream increases; and transmitting the generated video data to a server over a network.

It should be noted that the components described throughout this disclosure may be interchanged or combined. The components, features, and expressions described above may be replaced by devices, methods, systems, computer programs, recording media containing computer programs, etc. Any such modifications are intended to be included within the spirit and scope of the present disclosure.

### Advantageous Effects

According to the aspects of the disclosure, it is possible to realize the streaming system tailored to live-streaming in which a plurality of distributors participate.

### BRIEF DESCRIPTION OF THE DRAWINGS

FIG. 1 schematically illustrates a configuration of a live-streaming system in one embodiment of the disclosure.

FIG. 2 is a block diagram showing functions and configuration of a server shown in FIG. 1.

FIG. 3 is a data structure diagram showing an example of a profile holding unit of FIG. 2.

FIG. 4 is a data structure diagram of an example of a stream holding unit of FIG. 2.

FIGS. 5A to 5D schematically illustrate how a bit rate is controlled when the number of the distributors participating in a group call-type stream increases.

FIG. 6 is a block diagram showing an example of a hardware configuration of an information processing device according to the embodiment.

FIG. 7 is a flow chart showing a series of steps performed in a profile selection process in a modification example.

### DESCRIPTION OF THE EMBODIMENTS

Like elements, components, processes, and signals throughout the figures are labeled with same or similar designations and numbering, and the description for the like elements will not be hereunder repeated. For purposes of clarity and brevity, some of the components that are less related and thus not described are not shown in the figures.

The inventor of the present disclosure has obtained the following findings from our studies. During a group call, it sometimes happens that a video shown on the viewer's side becomes choppy or jumpy, or a video(s) of a distributor(s) freezes. The inventor first thought that this was due to a communication issue on viewers' side, but our study revealed that this was not the cause. As a result of further study, we found that this problem is more likely to occur when the number of the distributors participating in the group call increases.

In an embodiment according to the present disclosure, as the number of the distributors participating in the group call increases, video data is generated at a lower bit rate at user terminals of the distributors. In this way, even when the number of the distributors participating in the group call increases, it is possible to suppress an increase in the total amount of video data transmitted to user terminals of the viewers. As a result, it is possible to reduce the probability of buffering occurring in the viewers' user terminals, which reduce that chances of the choppy and frozen video reproduced on the viewers' user terminals.

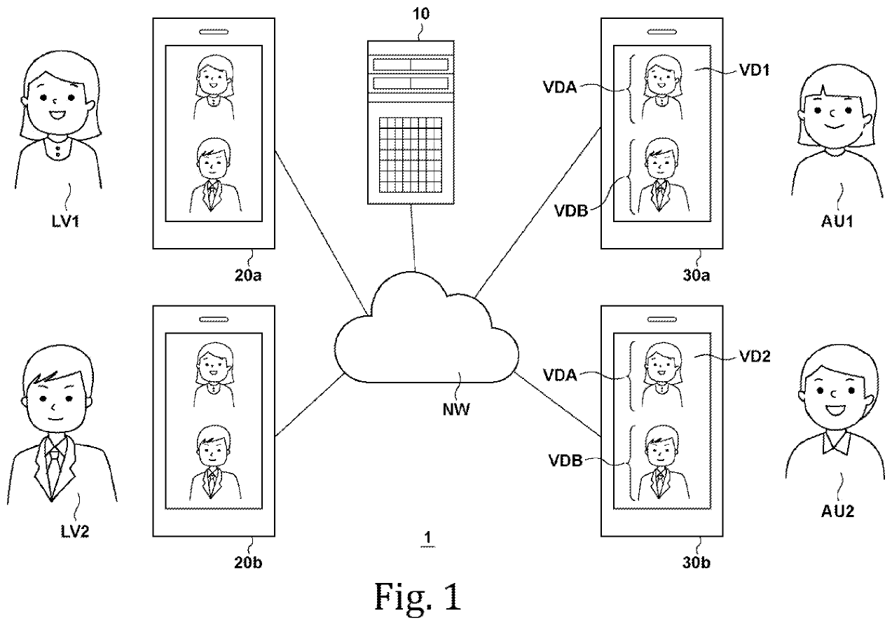

FIG. 1 schematically illustrates a configuration of a live-streaming system 1 according one embodiment of the disclosure. The live-streaming system 1 realizes the live-streaming (hereinafter referred to as a group call-type streaming) in which a plurality of distributors (also referred to as “livers” or “streamers”) can simultaneously participate, such as group call. The live-streaming system 1 provides an interactive live-stream service that allows a distributor LV (LV1, LV2) and a viewer AU (also referred to as audience) (AU1, AU2) to communicate in real time. As shown in FIG. 1, the live-streaming system 1 includes a server 10, user terminals 20 (20a, 20b) on the distributors' side, and user terminals 30 (30a, 30b) on the viewers' side. The distributor and viewers may be collectively referred to as users. The server 10 may be one or more information processing devices connected to a network NW. The user terminals 20 and 30 may be, for example, mobile terminal devices such as smartphones, tablets, laptop PCs, recorders, portable gaming devices, and wearable devices, or may be stationary devices such as desktop PCs. The server 10, the user terminal 20, and the user terminals 30 are interconnected so as to be able to communicate with each other over the various wired or wireless network NW.

The distributor LV and the viewers AU download and install a live-streaming application program (hereinafter referred to as a live-streaming application) according to the embodiment to the user terminals 20 and 30 from a download site over the network NW. Alternatively, the live-streaming application may be pre-installed on the user terminals 20 and 30. When the live-streaming application is executed on the user terminals 20 and 30, the user terminals 20 and 30 communicate with the server 10 over the network NW to implement various functions. Hereinafter, the functions implemented by (processors such as CPUs of) the user terminals 20 and 30 running the live-streaming application will be described as functions of the user terminals 20 and 30. These functions are realized in practice by the live-streaming application on the user terminals 20 and 30. In any other embodiments, these functions may be realized by a computer program that is written in a programming language such as HTML (HyperText Markup Language), transmitted from the server 10 to web browsers of the user terminals 20 and 30 over the network NW, and executed by the web browsers.

The user terminals 20, 30 each include a distribution unit that generates video data in which the user's image and sound are recorded and provides the video data to the server 10, and a viewing unit to which the video data is provided from the server 10 to reproduce the video data. The user activates the distribution unit when the user performs live-streaming, and activates the viewing unit when the user views a live-stream. The user terminal in which the distribution unit is activated is the distributor's terminal, i.e., the user terminal that generates the video data, and the user terminal in which the viewing unit is activated is the viewer's terminal, i.e., the user terminal in which the video data is reproduced or played.

The live-streaming system 1 involves the distributor LV, the viewers AU, and an administrator (not shown) who manages the server 10. The distributor LV is a person who broadcasts contents in real time by recording the contents with his/her user terminal 20 and uploading them directly to the server 1. Examples of the contents may include the distributor's own songs, talks, performances, fortune-telling, gameplays, and any other contents. The administrator provides a platform for live-streaming contents on the server 10, and also mediates or manages real-time interactions between the distributor LV and the viewers AU. The viewer AU accesses the platform at his/her user terminal 30 to select and view a desired content. During live-streaming of the selected content, the viewer AU performs operations to comment and cheer via the user terminal 30, the distributor LV who is delivering the content responds to such a comment and cheer, and such response is transmitted to the viewer AU via video and/or audio, thereby establishing an interactive communication.

The term “live-streaming” may mean a mode of data transmission that allows a content recorded at the user terminal 20 of the distributor LV to be played and viewed at the user terminals 30 of the viewers AU substantially in real time, or it may mean a live broadcast realized by such a mode of transmission. The live-streaming may be achieved using existing live delivery technologies such as HTTP Live Streaming, Common Media Application Format, Web Real-Time Communications, Real-Time Messaging Protocol and MPEG DASH. Live-streaming includes a transmission mode in which the viewers AU can view a content with a specified delay simultaneously with the recording of the content by the distributor LV. As for the length of the delay, it may be acceptable for a delay even with which interaction between the distributor LV and the viewers AU can be established. Note that the live-streaming is distinguished from so-called on-demand type transmission, in which the entire recorded data of the content is once stored on the server, and the server provides the data to a user at any subsequent time upon request from the user.

The term “video data” herein refers to data that includes image data (also referred to as moving image data) generated using an image capturing function of the user terminals 20 and 30, and audio data generated using an audio input function of the user terminals 20 and 30. Video data is reproduced in the user terminals 20 and 30, so that the users can view contents.

In the example of FIG. 1, the distributor LV1 and the distributor LV2 are participating in the group call-type streaming, and the distributor LV1 and the distributor LV2 are live-streaming his/her talk at the same time. The user terminal 20a of the distributor LV1 generates video data by recording images and sounds of the distributor LV1 talking, and the generated data is transmitted to the server 10 over the network NW. The user terminal 20b of the distributor LV2 also generates video data by recording images and sounds of the distributor LV2 talking, and the generated data is transmitted to the server 10 over the network NW.

The user terminals 30a and 30b of the viewers AU1 and AU2 respectively, who have requested the platform to view the group call-type live-stream in which the distributors LV1 and LV2 is participating, receive video data related to the group call-type live-stream (may also be herein referred to as “live-streaming video data”) over the network NW and reproduce the received video data to display video images VD1 and VD2, respectively, on the displays and output audio through the speakers. The video images VD1 and VD2 displayed on the respective user terminals 30a and 30b are substantially the same. The video image includes an area for displaying a video VDA captured by the user terminal 20a of the distributor LV1 and an area for displaying a video VDB captured by the user terminal 20b of the distributor LV2. The video VDA and the video VDB are reproduced simultaneously on the viewer's user terminal 30 and shown on the same screen of the display. The display area allocated to each of the videos VDA and VDB on the screen is smaller than the display area of a video of a single distributor when the distributor performs live-streaming. In the example of FIG. 1, the screen is half split. The audio outputted by the user terminals 30a and 30b are substantially the same, and include voices acquired by the user terminal 20a of the distributor LV1 and voices acquired by the user terminal 20b of the distributor LV2. The user terminal 20a of the distributor LV1 receives the recorded video VDB of the distributor LV2 over the network NW, and displays it on the display together with the recorded video VDA of the distributor LV1. The user terminal 20b of the distributor LV2 receives the recorded video VDA of the distributor LV1 over the network NW, and displays it on the display together with the recorded video VDB of the distributor LV2.

Recording of the images and sounds at the user terminal 20 of the distributor LV and reproduction of the video data at the user terminals 30 of the viewer AU are performed substantially simultaneously. Once the viewer AU1 types a comment about the contents of a talk by the distributor LV1 on the user terminal 30a, the server 10 displays the comment on the user terminal 20a of the distributor LV1 in real time and also displays the comment on the user terminals 30a and 30b of the viewers AU1 and AU2, respectively. When the distributor LV1 who read the comment and mentions or talks about the contents of the comment, a video and audio of the talk are outputted on the user terminals 30a and 30b of the viewers AU1 and AU2, respectively. This interactive action is recognized as establishment of a conversation between the distributor LV1 and the viewer AU1. In this way, the live-streaming system 1 realizes the group call-type live-streaming that enables the interactive communication, not one-way communication.

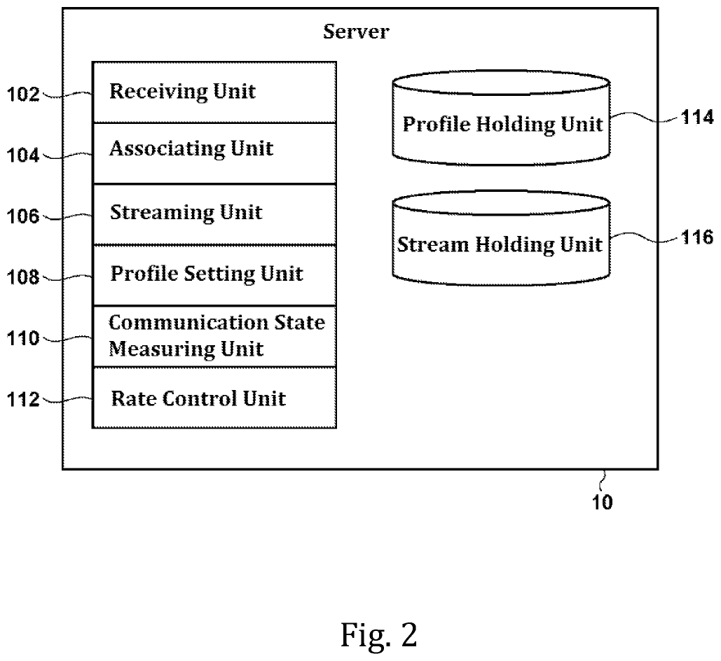

FIG. 2 is a block diagram showing functions and configuration of the server 10 of FIG. 1. Each block in FIG. 2 and the subsequent block diagrams may be realized by elements such as a computer CPU or a mechanical device in terms of hardware, and can be realized by a computer program or the like in terms of software. Functional blocks are realized by cooperative operation between these elements. Therefore, it is understood by those skilled in the art that these functional blocks can be realized in various forms by combining hardware and software.

The server 10 includes a receiving unit 102, an associating unit 104, a distribution unit 106, a profile setting unit 108, a communication state measuring unit 110, a rate control unit 112, a profile holding unit 114, and a stream holding unit 116.

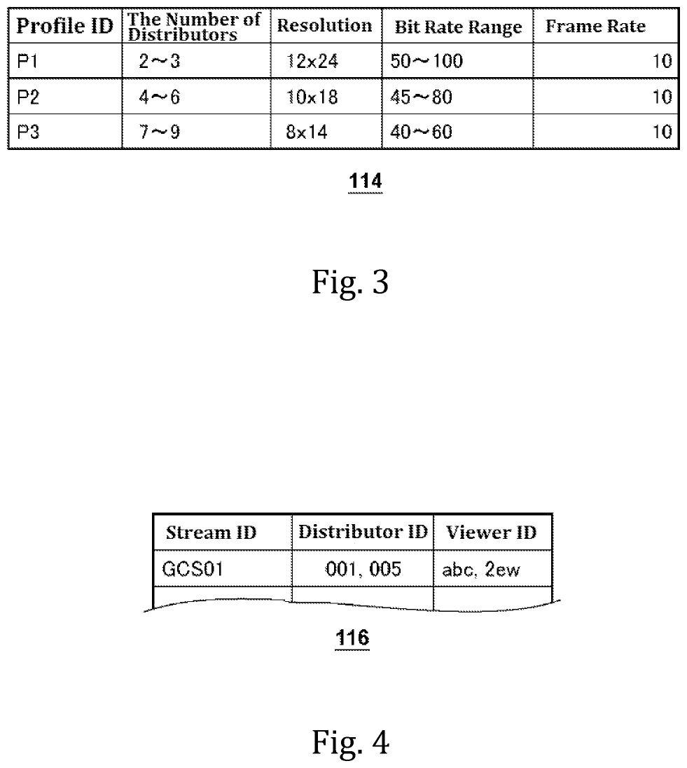

FIG. 3 is a data structure diagram showing an example of the profile holding unit 114 of FIG. 2. The profile holding unit 114 holds two or more different profiles set in advance by an administrator. The profile is a set of parameters that determine the quality and amount of video data generated by the user terminal 20 of the distributor LV and/or conditions on the parameters. The profile holding unit 114 holds a profile ID identifying a profile, and a range of the number of the distributors, a resolution, a bit rate range (lower limit and upper limit), and a frame rate that are specified in the profile, in association with each other. The resolution is represented by the number of vertical pixels and the number of horizontal pixels. The bit rate is the amount of data per unit time, and is expressed in units of bps (bits/second), for example. The frame rate is the number of frames per unit time, and is expressed in units of fps (frames/second), for example.

In the example of FIG. 3, profiles with profile IDs “P1”, “P2”, and “P3” correspond to high-quality, medium-quality, and low-quality videos, respectively. The plurality of profiles held in the profile holding unit 114 are set such that when the number of the distributors participating in the group call-type stream is increased and the upper limit of the bit rate is lowered, the frame rate is maintained and the resolution is decreased. Since the bit rate is proportional to the product of the resolution and the frame rate, either the resolution or the frame rate or both must be lowered when the bit rate is decreased. In this embodiment, the resolution is sacrificed to maintain the frame rate. As a result, even in the group call-type streaming, it is possible to realize the same smoothness of the video of the live-streaming performed by a single distributor. Moreover, in the group call-type streaming, the display area of each distributor's video image becomes smaller than that in live-streaming by a single distributor, so even if the resolution is lowered, the resulting deterioration of the image quality is relatively small and not apparent. In this way, the setting that absorbs a decrease in the bit rate by a decrease in the resolution and maintains the frame rate is suitable for the group call-type streaming.

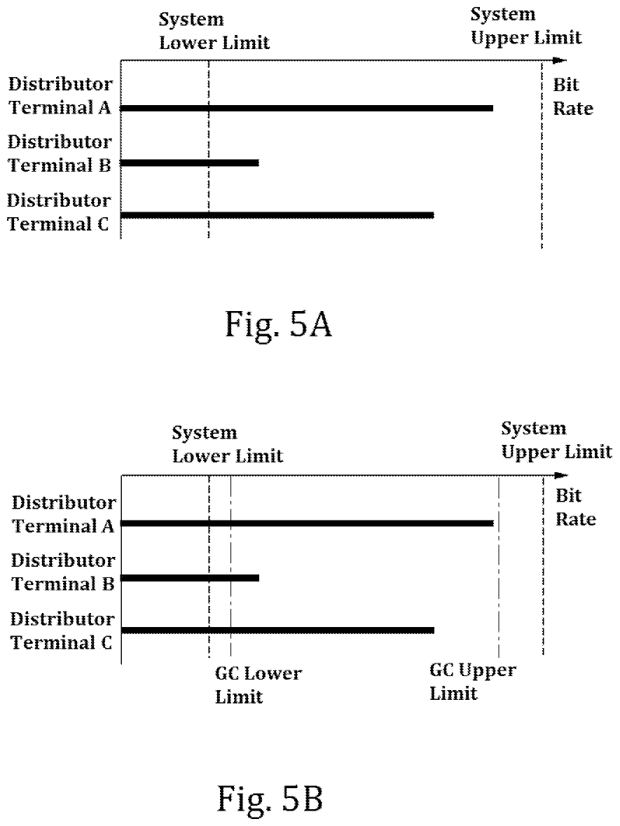

FIG. 4 is a data structure diagram showing an example of the stream holding unit 116 of FIG. 2. The stream holding unit 116 holds information regarding live-streams currently taking place. The stream holding unit 116 stores a stream ID for identifying a live-stream on a live distribution platform provided by the live-streaming system 1, a distributor ID, which is a user ID for identifying the distributor who provides the live-stream, and a viewer ID, which is a user ID for identifying a viewer of the live-stream, in association with each other. In the example of FIG. 4, the stream ID “GCS01” is an ID specifying a group call-type stream, and is associated with a plurality of distributor IDs.

Returning to FIG. 2, the receiving unit 102 receives video data over the network NW from the user terminals 20a and 20b of the distributors LV1 and LV2 participating in the group call-type stream. Hereinafter, video data generated by the user terminal 20a and transmitted to the server 10 will be referred to as first video data, and moving image data generated by the user terminal 20b and transmitted to the server 10 will be referred to as second video data.

The associating unit 104 associates the first video data and the second moving image data received by the receiving unit 102. The associating unit 104 may send the same stream ID in advance to the user terminal 20a of the distributor LV1 and the user terminal 20b of the distributor LV2. In this case, the same stream ID that has sent is assigned to the first video data and the second video data generated by the respective user terminals 20a and 20b, so that the first video data and the second video data are associated. Alternatively, the associating unit 104 obtains the distributor ID of the distributor LV1 attached to the received first video data, obtains the corresponding stream ID from the stream holding unit 116, and assigns it to the first video data. The associating unit 104 obtains the distributor ID of the distributor LV2 attached to the received second video data, obtains the corresponding stream ID from the stream holding unit 116, and assigns it to the second video data. All the distributor IDs of the distributors participating in the group call-type stream are associated with the same stream ID (stream ID identifying the group call-type stream), so that the stream ID obtained for the first video data matches the stream ID obtained for the second video data. Thereby, the first video data and the second video data are associated with each other.

The distribution unit 106 collectively transmits the first video data and the second video data associated by the associating unit 104 to the user terminals 30a and 30b of the viewers AU1 and AU2 of the group call-type stream over the network NW. The distribution unit 106 identifies a plurality of pieces of video data to which the stream ID of the group call-type stream is assigned, and collectively transmits the identified plurality of pieces of video data to the user terminal 30 of the viewer. The user terminal 30 collectively displays the video images obtained by reproducing the plurality of received video data on the same screen.

The profile setting unit 108 sets the upper limit of the bit rate of the video data generated by the user terminals 20 of the distributors LV participating in the group call-type stream such that the bit rate becomes lower as the number of the distributors participating in the group call-type stream increases. The profile setting unit 108 obtains the number of the distributors participating in group call-type stream periodically or when the number of the distributors participating in group call-stream increases or decreases. The profile setting unit 108 refers to the profile holding unit 114 and identifies the profile corresponding to the obtained number of distributors. As described above, the plurality of profiles registered in the profile holding unit 114 are defined such that the upper limit of the bit rate becomes lower as the number of the distributors participating in the group call-type stream increases.

The communication state measuring unit 110 measures the communication state between the server 10 and the user terminal(s) 20 of the distributor(s) LV participating in the group call-type stream. The known measure such as communication speed or bandwidth may be used to measure the communication state.

The rate control unit 112 dynamically controls the bit rates of video data generated by the user terminal(s) 20 of the distributor(s) LV participating in the group call-type stream depending on the measurement result(s) of the communication state measurement unit 110. The bit rate control performed by the rate control unit 112 is bound by the profile identified by the profile setting unit 108. The rate control unit 112 determines the bit rate within a range not exceeding the upper limit specified by the identified profile. It can be said that the bit rate determined in this way is an adjusted bit rate such that it becomes lower as the number of the distributors participating in the group call-type stream increases.

The rate control unit 112 informs the user terminals 20 of the distributors LV to which the measurement was performed by the communication state measurement unit 110 of the respective determined bit rates over the network NW. This may be realized by transmitting the determined bit rate as it is. Alternatively, a common bit rate codebook may be prepared for the server 10 and the user terminal 20 and the user terminal 20 may be informed of a code specifying the bit rate. The user terminal 20 of the distributor LV generates video data at the informed bit rate and transmits the generated video data to the server 10 over the network NW.

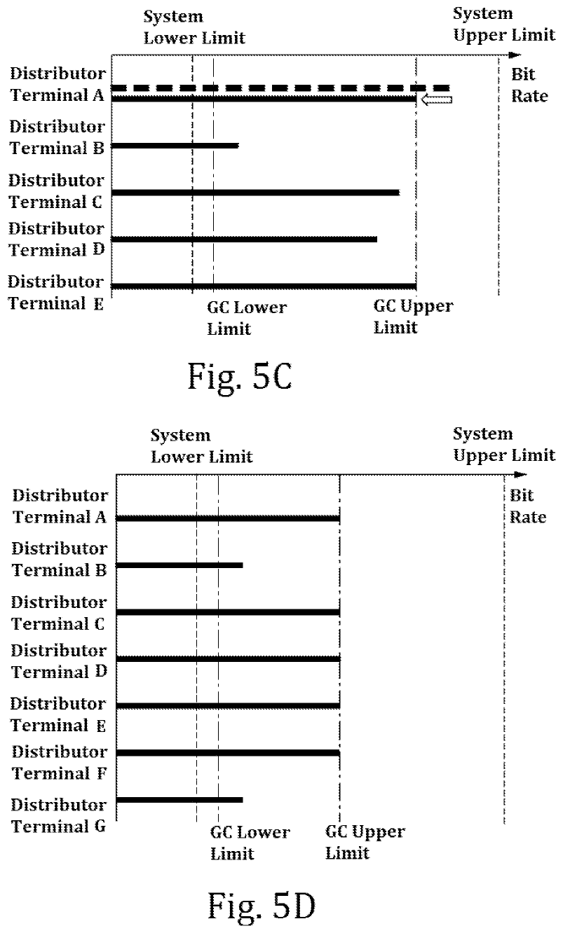

The operation of the live-streaming system 1 with the above configuration will be now described. FIGS. 5A to 5D schematically illustrate how the bit rates are controlled when the number of the distributors participating in the group call-type stream increases. FIG. 5A illustrates the state of the bit rates in a case of non-group call-type stream. A bit rate of video data generated by the user terminal of distributor A (hereinafter referred to as a distributor terminal A) is not bound by the profile. The bit rate is determined to have a value that is between a system upper limit and a system lower limit and depends on the communication state. For example, the bit rate becomes low when the communication state is poor, whereas the bit rate becomes high when the communication state is good. The communication state measurement unit 110 and rate control unit 112 increase, decrease, or change the bit rate depending on changes in the communication state. The same applies to the distributors B and C.

FIG. 5B illustrates the state of the bit rates in a case where the three distributors A, B, and C are participating in the group call-type stream. The number of the distributors participating in the group call-type stream is three, and the profile “P1” (see FIG. 3) corresponding to this number of the distributors is identified. This profile “P1” defines an upper limit (hereinafter referred to as GC upper limit) and a lower limit (hereinafter referred to as GC lower limit) of the bit rate. Here, the GC upper limit is lower than the system upper limit, and the GC lower limit is higher than the system lower limit. The bit rate of the video data generated by each of the distributor terminals A, B, and C is determined such that it does not exceed the GC upper limit and it does not fall below the GC lower limit. In the example of FIG. 5B, for the distributor terminal A, the bit rate determined depending on the communication state is lower than the GC upper limit value, so the determined bit rate is adopted as it is.

FIG. 5C shows the state of the bit rates when the number of the distributors participating in the group call-type stream increases by two from the state of FIG. 5B to the five distributors A, B, C, D, and E. The number of the distributors participating in the group call-type stream is five, and the profile “P2” (see FIG. 3) corresponding to this number is identified. In the state of FIG. 5C, the GC upper limit is lower than that for the state of FIG. 5B. Thus, the bit rate determined depending on the communication state of the distributor terminal A exceeds the GC upper limit, so the bit rate of the distributor terminal A is set to the GC upper limit. The same happens to the distributor terminal E, and the bit rate of the distributor terminal E is also set to the GC upper limit.

FIG. 5D shows the state of the bit rates when the number of the distributors participating in the group call-type stream increases by two from the state of FIG. 5C to the seven distributors A, B, C, D, E, F and G. The number of the distributors participating in the group call-type stream is seven, and the profile “P3” (see FIG. 3) corresponding to this number is identified. In the state of FIG. 5D, the GC upper limit is lower than that for the state of FIG. 5C. Thus, the bit rates determined depending on the communication states of the distributor terminals A, C, D, E, and F exceed the GC upper limit, so the bit rates of the distributor terminals A, C, D, E, and F are set to the GC upper limit value.

In the above embodiment, an example of the holding unit includes a hard disk or semiconductor memory. It is understood by those skilled in the art that each element or component can be realized by a CPU not shown, a module of an installed application program, a module of a system program, or a semiconductor memory that temporarily stores the contents of data read from a hard disk, and the like.

In the live-streaming system 1 according to the embodiment, as the number of the distributors participating in the group call-type stream increases, the bit rate of video data generated by the user terminal of each distributor decreases. Even when the communication state is good and a high bit rate is possible, the bit rate is set so as not to exceed the upper limit value set depending on the number of the distributors participating in the group call-type stream. Therefore, it is possible to reduce the amount of video data received by each of the user terminals of the viewers who participate in the group call-type stream, thereby realizing smooth reproduction of the group call-type stream on the user terminals of the viewers.

The user terminals of the viewers who participate in the group call-type stream receive the video data of all the participating distributors collectively, so as the number of the participating distributors increases, the amount of video data received also increases. This increase of data volume hinders smooth reproduction of the group call-type stream. To address this, in the embodiment, the bit rate is controlled depending on the number of participants when generating the video data, thereby suppressing the increase in the amount of data. Therefore, smooth reproduction of the video data can be maintained even if the number of the distributors participating in the group call-type stream increases.

The amount of video data can also be reduced by transcoding or the like at the server 10, however transcoding generally increases delay. A real-time performance is most important for live-streaming, so the method of the embodiment is more appropriate because the bit rate is limited at the stage of the video data generation and the method does not rely on transcoding as much as possible. For example, it is not necessary to transcode the video data after the video data is generated on the user terminal of the distributor and until the video data transmitted via the server 10 is reproduced on the user terminal of the viewer. In this case, it is possible to realize a group call-type stream with less delay and smooth reproduction even when the number of participants increases.

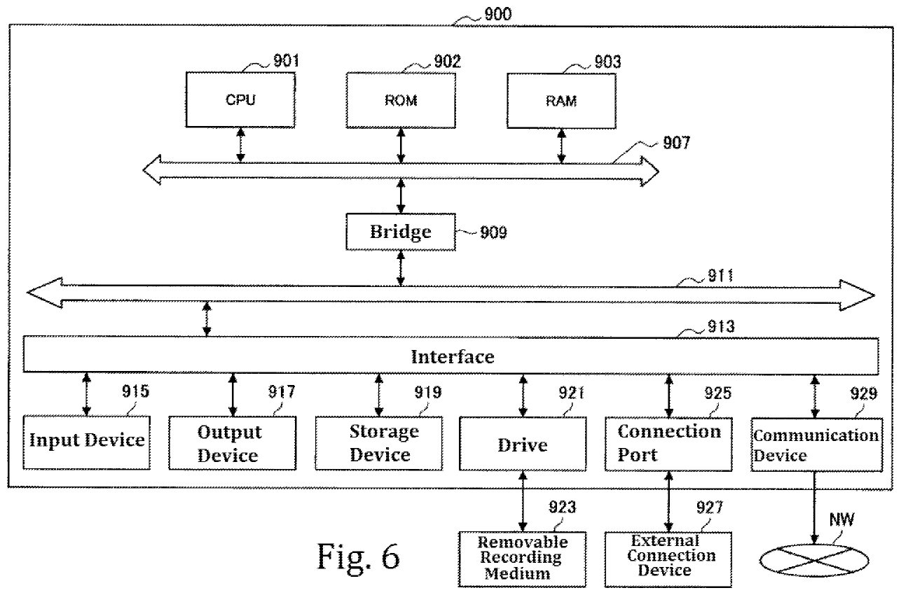

Referring to FIG. 6, the hardware configuration of the information processing device will be now described. FIG. 6 is a block diagram showing an example of the hardware configuration of the information processing device according to the embodiment. The illustrated information processing device 900 may, for example, realize the server 10 and the user terminals 20 and 30 in the embodiment.

The information processing device 900 includes a CPU 901, ROM (Read Only Memory) 902, and RAM (Random Access Memory) 903. The information processing device 900 may also include a host bus 907, a bridge 909, an external bus 911, an interface 913, an input device 915, an output device 917, a storage device 919, a drive 921, a connection port 925, and a communication device 929. In addition, the information processing device 900 includes an image capturing device such as a camera (not shown). In addition to or instead of the CPU 901, the information processing device 900 may also include a DSP (Digital Signal Processor) or ASIC (Application Specific Integrated Circuit).

The CPU 901 functions as an arithmetic processing device and a control device, and controls all or some of the operations in the information processing device 900 according to various programs stored in the ROM 902, the RAM 903, the storage device 919, or a removable recording medium 923. For example, the CPU 901 controls the overall operation of each functional unit included in the server 10 and the user terminals 20 and 30 in the embodiment. The ROM 902 stores programs, calculation parameters, and the like used by the CPU 901. The RAM 903 serves as a primary storage that stores a program used in the execution of the CPU 901, parameters that appropriately change in the execution, and the like. The CPU 901, ROM 902, and RAM 903 are interconnected to each other by the host bus 907 which may be an internal bus such as a CPU bus. Further, the host bus 907 is connected to the external bus 911 such as a PCI (Peripheral Component Interconnect/Interface) bus via the bridge 909.

The input device 915 may be a user-operated device such as a mouse, keyboard, touch panel, buttons, switches and levers, or a device that converts a physical quantity into an electric signal such as a sound sensor typified by a microphone, an acceleration sensor, a tilt sensor, an infrared sensor, a depth sensor, a temperature sensor, a humidity sensor, and the like. The input device 915 may be, for example, a remote control device utilizing infrared rays or other radio waves, or an external connection device 927 such as a mobile phone compatible with the operation of the information processing device 900. The input device 915 includes an input control circuit that generates an input signal based on the information inputted by the user or the detected physical quantity and outputs the input signal to the CPU 901. By operating the input device 915, the user inputs various data and instructs operations to the information processing device 900.

The output device 917 is a device capable of visually or audibly informing the user of the obtained information. The output device 917 may be, for example, a display such as an LCD, PDP, or OELD, etc., a sound output device such as a speaker and headphones, and a printer. The output device 917 outputs the results of processing by the information processing device 900 as text, video such as images, or sound such as audio.

The storage device 919 is a device for storing data configured as an example of a storage unit of the information processing device 900. The storage device 919 is, for example, a magnetic storage device such as a hard disk drive (HDD), a semiconductor storage device, an optical storage device, or an optical magnetic storage device. This storage device 919 stores programs executed by the CPU 901, various data, and various data obtained from external sources.

The drive 921 is a reader/writer for the removable recording medium 923 such as a magnetic disk, an optical disk, a photomagnetic disk, or a semiconductor memory, and is built in or externally attached to the information processing device 900. The drive 921 reads information recorded in the mounted removable recording medium 923 and outputs it to the RAM 903. Further, the drive 921 writes record in the attached removable recording medium 923.

The connection port 925 is a port for directly connecting a device to the information processing device 900. The connection port 925 may be, for example, a USB (Universal Serial Bus) port, an IEEE1394 port, an SCSI (Small Computer System Interface) port, or the like. Further, the connection port 925 may be an RS-232C port, an optical audio terminal, an HDMI (registered trademark) (High-Definition Multimedia Interface) port, or the like. By connecting the external connection device 927 to the connection port 925, various data can be exchanged between the information processing device 900 and the external connection device 927.

The communication device 929 is, for example, a communication interface formed of a communication device for connecting to the network NW. The communication device 929 may be, for example, a communication card for a wired or wireless LAN (Local Area Network), Bluetooth (trademark), or WUSB (Wireless USB). Further, the communication device 929 may be a router for optical communication, a router for ADSL (Asymmetric Digital Subscriber Line), a modem for various communications, or the like. The communication device 929 transmits and receives signals and the like over the Internet or to and from other communication devices using a predetermined protocol such as TCP/IP. The communication network NW connected to the communication device 929 is a network connected by wire or wirelessly, and is, for example, the Internet, home LAN, infrared communication, radio wave communication, satellite communication, or the like. The communication device 929 realizes a function as a communication unit.

The image capturing device (not shown) is, for example, a camera for capturing an image of the real space to generate the captured image. The image capturing device uses an imaging element such as a CCD (Charge Coupled Device) or CMOS (Complementary Metal Oxide Semiconductor) and various elements such as lenses that are provided to control image formation of a subject on the imaging element. The image capturing device may capture a still image or may capture a moving image.

The configuration and operation of the live-streaming system 1 in the embodiment have been described. This embodiment is a merely example, and it is understood by those skilled in the art that various modifications are possible for each component and a combination of each process, and that such modifications are also within the scope of the present disclosure.

The above embodiment described the case where the server 10 dynamically determines the upper limit of the bit rate from the number of the distributors participating in the group call-type stream, further determines the bit rate that falls within a range not exceeding the upper limit depending on the communication state, and the determined bit rate is notified to the user terminal of the distributor. However, the embodiment is not limited to this. For example, the server 10 may obtain the number of the distributors participating in group call-type stream, and inform the user terminals of all the distributors participating in the group call-type stream of the obtained number of the distributors. In this case, the user terminals of the distributors have information corresponding to that of the profile holding unit 114, and determine the upper limit of the bit rate by referring to the information based on the informed number. Furthermore, the user terminal obtains the communication state either by measuring by itself or by obtaining a measurement result from the communication state measurement unit 110, and determines the bit rate that falls within a range not exceeding the upper limit depending on the obtained communication state. It can be said that the bit rate determined in this way is an adjusted bit rate such that it becomes lower as the number of the distributors participating in the group call-type stream increases.

Alternatively, the server 10 may determine the upper limit of the bit rate such that the greater the number of the distributors participating in the group call-type stream, the lower the bit rate. The user terminals of all the distributors of the group call-type stream may be informed of the determined upper limit.

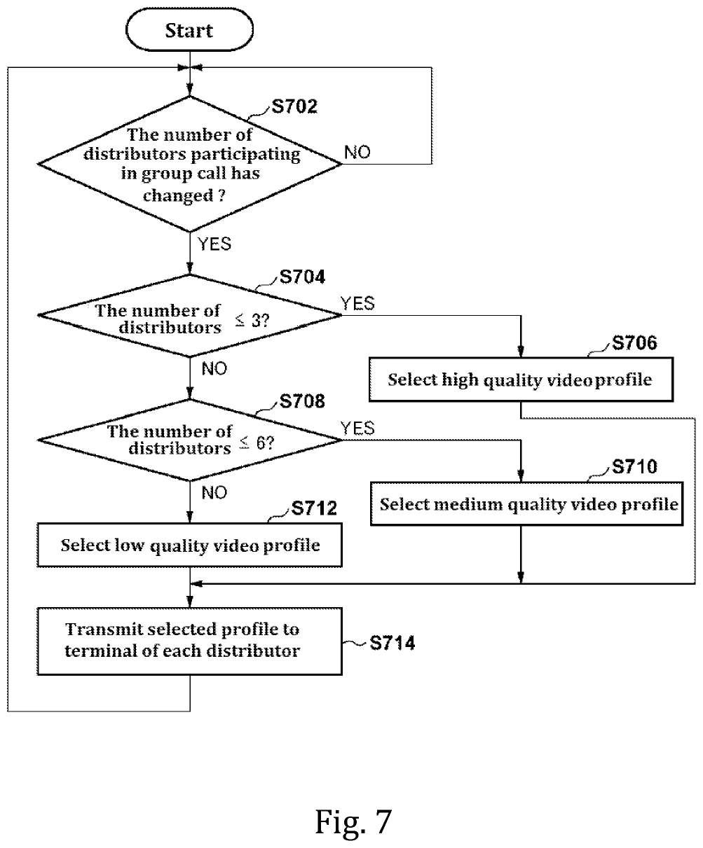

FIG. 7 is a flow chart showing a series of steps performed in a profile selection process in a modification example. The server 10 determines whether the number of the distributors participating in the group call-type stream has changed (S702). When it is determined that the number of the distributors has changed (Y in S702), the server 10 determines whether the current number of the distributors after the change is three or less (S704). When it is three or less (Y in S704), the server 10 selects a profile with the highest bit rate limit, in other words, a highest quality video profile (S706). When it is greater than three (N in S704), the server 10 determines whether the current number of the distributors after the change is six or less (S708). When it is six or less (Y in S708), the server 10 selects a profile with an intermediate bit rate limit, in other words, a medium quality video profile (S710). When it is greater than six (N in S708), the server 10 selects a profile with the lowest bit rate limit, in other words, a lowest quality video profile (S712). The server 10 informs or transmits the profile selected in step S706, S710 or S712 to the user terminal of each distributor (S714). The process then returns to step S702.

In this case, the user terminal of the distributor receives the upper limit. The user terminal obtains the communication state either by measuring by itself or by obtaining a measurement result from the communication state measurement unit 110, and determines the bit rate that falls within a range not exceeding the upper limit and depends on the obtained communication state. It can be said that the bit rate determined in this way is an adjusted bit rate such that it becomes lower as the number of the distributors participating in the group call-type stream increases.

In the embodiment, multiple pieces of video data of multiple distributors participating in the group call-type stream are sent to the viewer's user terminal in association with each other, and a screen of the group call type-stream is configured by reproducing the multiple pieces of video data on the viewer's user terminal respectively. However, the embodiment is not limited to this. For example, the server 10 may generate new video data for the group call-type stream by combining the multiple pieces of video data of the multiple distributors, and transmit the generated video data to the viewer's user terminal. The same advantageous effects as those achieved by the live streaming system 1 according to the embodiment can also be obtained.

In the above embodiment, a plurality of profiles are prepared and the profile corresponding to the number of distributors participating in group call-type stream is selected from among them. However the disclosure is not limited to this. For example, the server 10 may measure the communication state between the user terminals of the viewers watching the group call-type stream and the server 10, and may adjust the upper limit of the bit rate defined in each profile depending on the measured communication state. For example, the server 10 may control the upper limit of the bit rate such that the bit rate becomes higher as the measured communication state is better.

The technical idea according to the embodiment may be applied to live commerce or virtual live-streaming using an avatar that moves in synchronization with the movement of the distributor instead of the image of the distributor.

The procedures described herein, particularly those described with a flow diagram, a flowchart, are susceptible of omission of part of the steps constituting the procedure, adding steps not explicitly included in the steps constituting the procedure, and/or reordering the steps. The procedure subjected to such omission, addition, or reordering is also included in the scope of the present invention unless diverged from the purport of the present invention.

At least some of the functions realized by the server 10 may be realized by a device(s) other than the server 10, for example, the user terminals 20 and 30. At least some of the functions realized by the user terminals 20 and 30 may be realized by a device(s) other than the user terminals 20 and 30, for example, the server 10.

In the embodiment, the format and specifications may or may not be changed by transcoding or the like after the video data is generated on the user terminal of the distributor and until the video data is reproduced on the user terminal of the viewer.

What is claimed is:

1. A server, comprising:
a determining unit adapted to determine either a bit rate or an upper limit of the bit rate of video data generated by a user terminal of a distributor, the distributor participating in a live-stream in which a plurality of distributors are allowed to participate, the bit rate or the upper limit of the bit rate being determined such that the bit rate or the upper limit of the bit rate is lowered as a number of the distributors participating in the live-stream increases;
an informing unit adapted to inform the user terminal of the distributor of the determined bit rate or the upper limit over a network; and
a receiving unit adapted to receive the video data from user terminals of the plurality of distributors participating in the live-stream over the network.

2. The server of claim 1, wherein the determining unit determines the upper limit of the bit rate, and
wherein the informing unit informs user terminals of all the distributors participating the live-stream of the determined upper limit of the bit rate.

3. The server of claim 1, further comprising a transmitting unit adapted to collectively transmit a plurality of pieces of video data received from user terminals of the plurality of distributors.

4. The server of claim 1, wherein a frame rate is maintained and a resolution is decreased when the bit rate or the upper limit is lowered, and
wherein, at a user terminal of a viewer of the live-stream, a display area allocated to each distributor is smaller than a display area for an image of a single distributor of a live-stream performed by the single distributor.

5. The server of claim 1, wherein
the determining unit includes:
an upper-limit determining unit adapted to determine the upper limit of the bit rate of the video data generated by the user terminal of the distributor such that the upper limit is lowered as the number of the distributors participating in the live-stream increases; and
a bit-rate determining unit adapted to determine the bit rate of the video data generated by the user terminal depending on a communication state between the user terminal of the distributor and the server, the bit rate falling within a range not exceeding the determined upper limit,
wherein the informing unit informs of the determined bit rate.

6. The server of claim 1, wherein the determining unit determines the bit rate or the upper limit such that the bit rate or the upper limit is lowered as the number of the distributors simultaneously participating in the live-stream increases, regardless of a number of viewers participating in the live-stream.

7. A method, comprising:
determining a bit rate or an upper limit of the bit rate of video data generated by a user terminal of a distributor participating in a live-stream in which a plurality of distributors are allowed to participate such that the bit rate of the upper limit is lowered as a number of the distributors participating in the live-stream increases;
informing the user terminal of the distributor of the determined bit rate or upper limit over a network; and
receiving the video data from user terminals of the plurality of distributors participating in the live-stream over the network.

8. The method of claim 7, wherein the determining includes determining the upper limit of the bit rate, and
wherein the informing includes informing user terminals of all the distributors participating the live-stream of the determined upper limit of the bit rate.

9. The method of claim 7, further comprising collectively transmitting a plurality of pieces of video data received from user terminals of the plurality of distributors.

10. The method of claim 7, wherein a frame rate is maintained and a resolution is decreased when the bit rate or the upper limit is lowered, and
wherein, at a user terminal of a viewer of the live-stream, a display area allocated to each distributor is smaller than a display area for an image of a single distributor of a live-stream performed by the single distributor.

11. The method of claim 7, wherein
the determining includes:
determining the upper limit of the bit rate of the video data generated by the user terminal of the distributor such that the upper limit is lowered as the number of the distributors participating in the live-stream increases; and
determining the bit rate of the video data generated by the user terminal depending on a communication state between the user terminal of the distributor and the server, the bit rate falling within a range not exceeding the determined upper limit,
wherein the informing includes informing of the determined bit rate.

12. The method of claim 7, wherein the determining includes determining the bit rate or the upper limit such that the bit rate or the upper limit is lowered as the number of the distributors simultaneously participating in the live-stream increases, regardless of a number of viewers participating in the live-stream.

13. A user terminal of a distributor participating in a live-stream in which a plurality of distributors are allowed to participate, comprising:
one or more processors; and
memory storing one or more computer programs configured to be executed by the one or more processors,
the one or more computer programs including instructions for:
generating video data at a bit rate that is adjusted the bit rate is lowered as a number of the distributors participating in the live-stream increases; and
transmitting the generated video data to a server over a network.

14. The user terminal of claim 13, wherein the one or more computer programs further includes instructions for:
receiving, from the server over the network, an upper limit of the bit rate that is determined such that the upper limit is lowered as the number of the distributors participating in the live-stream increases; and
determining the bit rate depending on a communication state between the user terminal of the distributor and the server, the bit rate falling within a range not exceeding the received upper limit.
